(19) United States
(12) Patent Application Publication
(10) Pub. No.: US 2022/0174913 A1
(43) Pub. Date: Jun. 9, 2022

(54) HONEYCOMB FOUNDATION HAVING MULTIPLE CELL SIZES

(71) Applicants: KEVIN JESTER, MIMS, FL (US); PRATIMA JESTER, MIMS, FL (US)

(72) Inventors: KEVIN JESTER, MIMS, FL (US); PRATIMA JESTER, MIMS, FL (US)

(21) Appl. No.: 17/110,414

(22) Filed: Dec. 3, 2020

(51) Int. Cl. A01K 47/04; A01K 47/06

(52) U.S. Cl. CPC A01K 47/04; A01K 47/06

(57) ABSTRACT

The present invention provides an artificial honeycomb foundation for beehives wherein a single foundation sheet includes cells of more than one size to accommodate both worker bees and drone bees. An array of hexagonally-shaped cells may be provided on either or both sides of a dividing film wall. Within the array of cells on each side of the dividing film wall there are provided an array of worker bee sized cells, typically in the range of between about 4.6 mm and 5.5 mm, and an array of drone bee sized cells, typically in the range of between about 6.4 mm and 6.6 mm. The hexagonally-shaped honeycomb cells projecting from the front surface of the dividing film wall are offset from the hexagonally-shaped honeycomb cells projecting from the rear surface of the dividing film wall.

### BACKGROUND OF THE INVENTION

### Field of the Invention

The present invention relates to artificial honeycomb foundations for beehives. More specifically, the present invention relates to an artificial honeycomb foundation for beehives wherein a single foundation sheet includes cells of more than one size to accommodate both worker bees and drone bees.

### Description of the Related Art

Since 1857 when Johannes Mehring produced the first artificial comb foundation, bee keepers have sought to find a satisfactory method for replicating honeycomb as produced by bees in the wild. The goal of these early beekeepers, and beekeepers today, was to provide the bees with a template that would encourage worker bees to build combs on the frames. The honeycomb midrib, which supplied an array of hexagonal cells on both sides of a sheet, became a popular choice for beekeepers. Bees draw comb with regular, predetermined characteristics more quickly and more economically, from such a foundation.

Each hive has one queen, whose only job is to lay eggs. It is important for the health of the hive and the bees to have a mix of worker bees and drone bees within the hive. The primary function of the drone bees is to mate with the queen bee, while the primary function of the worker bees is to perform all “work” that takes place in the hive, including collecting nectar and pollen, taking care of the brood, and cleaning and guarding the hive. Since pollination of crops and/or honey production are the “cash crops” of a managed hive, many tend to ignore the importance of drone bees in managed hives, particularly when the hive already includes a mated queen. However, research has shown that hives that include a healthy mix of drone bees and worker bees are healthier overall.

Typically, in nature, bees reproduce, or “swarm” in the spring, when the first virgin queen is almost ready to emerge. The old queen and about half of the bees will leave the hive in search of a location to establish a new hive where combs are quickly constructed, brood rearing starts, and nectar and pollen are gathered. After the swarm departs, the remaining worker bees in the parent colony continue their work, including the rearing of a new virgin queen. When mature, the new queen flies out of the hive to mate with multiple drones from nearby hives. The drones die after mating, so it's important that all hives in an area have the means for producing and raising new drone bees to mate with queens from nearby hives. In a natural hive, there are typically drone bees present to mate with a queen from a nearby hive. However, in a managed hive consisting of foundation sheets with cells sized only for worker bees, there may not be enough drones present to mate with queens from nearby hives.

Modern pollination practices with artificial commercial hives have also disrupted the natural cycle of a hive. A natural hive is at it peak production level in the spring. However, at present in the United States, approximately 80% of the commercial bee hives are shipped to California in February to assist in the pollination process for almonds. A typical hive is not very active at this time of year. In order to have the hives ready for production in February, it is necessary to stimulate the bees in mid-winter to get them ready. Rather than relying on the natural process of splitting hives in the spiring, modern beekeepers need to split hives later in the season, perhaps multiple time per year. In order to accomplish this task, a healthy population of drone bees is needed.

In practice, an artificial beehive starts with a box, which is the building block of a Langstroth hive. Typically a hive starts with a single box, generally a medium or a deep. Then additional boxes are added as the colony matures and grows. These are generally medium or deep, too, though some beekeepers like to use shallow boxes for honey supers. Langstroth boxes are generally available in two sizes—8 or 10 frame (“nucs” are smaller and typically hold 4 or 5 frames).

An appropriate number of frames (8 or 10 as discussed above) may be inserted into the box. The dimensions of the box, the frames and the spacers (which keep the main bodies of the frames apart) are carefully designed to respect “bee space”. Alternatively, some beekeepers don't use a full rectangular frame, preferring to instead just rest a “top bar” along the upper part of each box.

Within each frame, or extending from each top bar is the foundation, which is the physical plane on which bees create their own combs. Foundation can either be manufactured (man-made) or natural. The present invention concerns manufactured foundations which can be made of plastic, with or without a layer of beeswax, or a synthetic comb. With the exception of the latter, bees will build their own comb on top of the foundation.

The foundations that are presently available have cells which are of a uniform size. That is to say that a worker bee foundation would have a plurality of hexagonally-shaped cells in the size range of approximately 4.6 mm to 5.5 mm, while a drone bee foundation would have a plurality of hexagonally-shaped cells in the size range of approximately 6.4 mm to 6.6 mm. In order to provide for both worker cells and drone cells within the same box, the beekeeper must insert one or more foundations of each type in the box. For example, in a 10 frame box, a beekeeper might install nine (9) worker bee foundations with cell sizes in the range of 4.6 mm to 5.5 mm and one (1) drone bee foundation with cell sizes in the range of 6.4 mm to 6.6 mm.

Drone sheets are typically only used for raising queens in a hive or to combat varroa. In most instances, a full sheet of drone cells in an artificial hive that is not designed specifically for raising queens is too much. Use of a full drone sheet may result it too many drone bees or in empty drone cells later in the season as the queen will not lay eggs in those cells later in the season.

In a natural hive, the drone cells and worker cells are not so distinctly divided. Rather than being present on a separate sheet, the drone cells in a natural hive are dispersed throughout the hive alongside the worker cells. Also, in artificial hives where the foundations are made of beeswax as they were in the past, the natural decomposition of the beeswax foundation was repaired by the bees which resulted in cells of different sizes that could accommodate drone bees. However, with the more durable plastic foundations that are used today, there is little if any deterioration of the cells which results in uniformity of the combs produced by the bees on those foundations.

Accordingly, there is a need for a foundation for an artificial bee hive that includes cells sized to accommodate worker bees with cells sized to accommodate drone bees interspersed throughout the same frame.

### SUMMARY OF THE INVENTION

It is therefore an object of the present invention to provide an artificial honey bee hive that more closely resembles a natural hive by including a plurality drone bee sized cells interspersed amongst the more prevalent worker bee sized cells.

It is also an object of the invention to provide an artificial honeycomb foundation that includes a mixture of both worker bee sized cells and drone bee sized cells in order to ensure sufficient drones are present in the hive throughout the year.

The present invention meets these objects by providing an artificial honeycomb foundation for beehives having a combination of worker sized cells and drone sized cells in the same foundation.

According to one presently preferred embodiment of the invention, there is provided an artificial honeycomb foundation for beehives comprising a dividing film wall which acts as a base for the artificial honeycomb foundation, and an array of hexagonally-shaped honeycomb cells projecting from a first surface of the dividing film wall. A first group of the array of hexagonally-shaped honeycomb cells include cells of a first dimension sized to accommodate worker bees. A second group of the array of hexagonally-shaped honeycomb cells include cells of a second, larger dimension sized to accommodate drone bees.

A second array of hexagonally-shaped honeycomb cells may be provided projecting from a second surface of the dividing film wall. Like the first array, a first group of the second array of hexagonally-shaped honeycomb cells include cells of a first dimension sized to accommodate worker bees, and a second group of the second array of hexagonally-shaped honeycomb cells include cells of a second, larger dimension sized to accommodate drone bees. The hexagonally-shaped honeycomb cells projecting from the first surface of the dividing film wall may be offset from the hexagonally-shaped honeycomb cells projecting from the second surface of the dividing film wall.

The worker bee cells may preferably be between about 4.6 mm and 5.5 mm in width, and the drone bee cells may preferably be between about 6.4 mm and 6.6 mm in width. Other dimensions for the worker bee cells and drone bee cells are contemplated, namely an array with worker cells between about 4.57 mm and 5.59 mm in width, with a preferred width of 5.08 mm, and drone cells between about 5.72 mm and 6.99 mm in width, with a preferred width of 6.35 mm. Alternatively, there can be provided an array where worker cells are between about 4.29 mm and 5.24 mm in width, with a preferred width of 4.76 mm, and drone cells are between about 5.36 mm and 6.55 mm in width, with a preferred width of 5.95 mm. Another alternative preferred embodiment provides worker cells between about 4.50 mm and 5.50 mm in width, with a preferred width of 5.00 mm, and drone cells between about 5.63 mm and 6.88 mm in width, with a preferred width of 6.25 mm.

The drone bee cells preferably account for less than fifteen percent of the array of hexagonally-shaped honeycomb cells, and more preferably, approximately two percent of the array of hexagonally-shaped honeycomb cells.

Each cell in the array of hexagonally-shaped honeycomb cells may consist of a shallow three-dimensional lattice of substantially equal length struts defining a regular array of substantially equal closely packed rhombic lattice openings such that each rhombic opening shares each of its four peripheral struts with a respective adjacent rhombic opening.

The array of hexagonally-shaped honeycomb cell is preferably formed from a plastic material such as styrene. Alternatively, the array of hexagonally-shaped honeycomb cells may be formed from wax or metal.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a front elevational view of a honeycomb foundation sheet according to a presently preferred embodiment of the invention.

FIG. 2 is an end elevational view of the honeycomb foundation sheet shown in FIG. 1.

FIG. 3 is an enlarged elevational view of the area bound by the circle “A” shown in FIG. 1.

FIG. 4 is an enlarged elevational view of the area bound by the circle “B” shown in FIG. 1.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

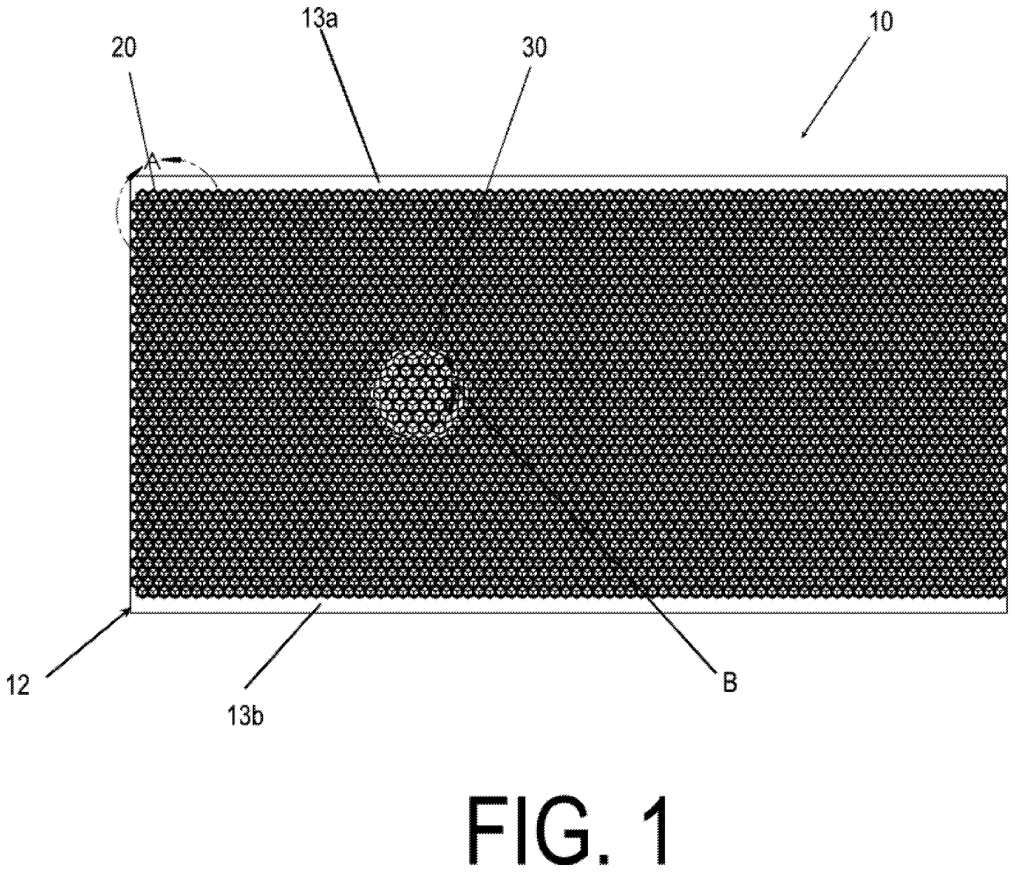

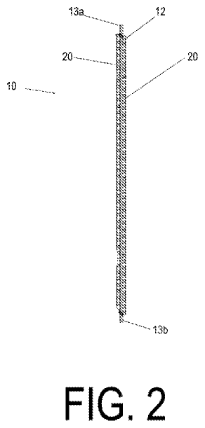

As best shown in FIG. 1 and FIG. 2, one presently preferred embodiment of the invention comprises a honeycomb foundation sheet 10 for beehives which comprises a first complex of hexagonal worker bee cells 20 sized to accommodate worker bees and a second complex of hexagonal drone bee cells 30 sized to accommodate drone bees. The hexagonal cells 20, 30 are preferably located on either side of a dividing film wall 12 which acts as the base for the hexagonal cells 20, 30. The hexagonal cells 20, 30 on one side of the dividing wall 12 are off-set with respect to those on the opposite side (see FIG. 2), which permits greater consistency and strength of the honeycomb structure.

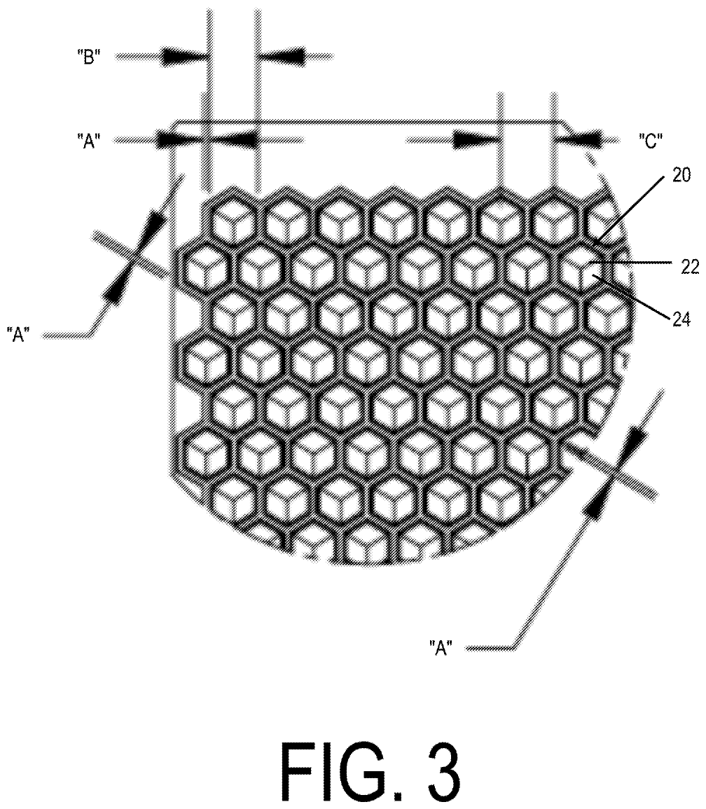

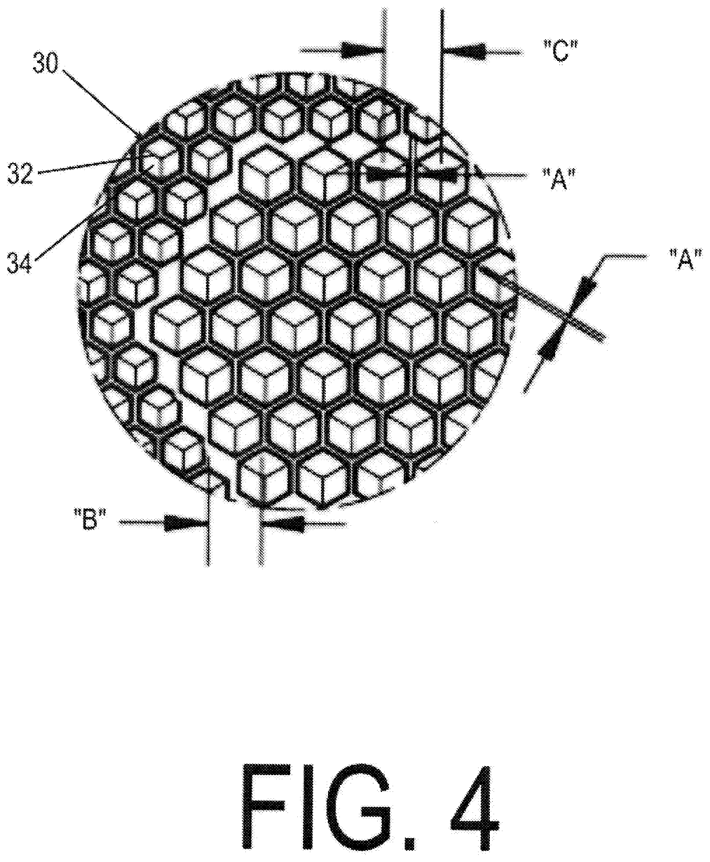

As best shown in FIG. 2, a plurality of depressions are defined on each side of the dividing wall 12, and are framed by a plurality of struts 22, 32 (see FIGS. 3, 4), each depression having a substantially hexagonal peripheral rim when viewed normal to the sheet and whose struts 22, 32 define three substantially equal rhombic openings 24, 34 corresponding to the three facets of natural honeycomb cell bases. The upper and lower edges of the dividing wall 12 do not carry cells thereon, but exhibit flanges 13a, 13b which assist in insertion of the foundation sheet 10 into a frame (not shown), and ultimately into a hive. The dividing wall 12 can be of any thickness that serves the required functions, and preferably is approximately 1.524 mm thick. Similarly, the thickness of the entire foundation sheet can vary greatly depending upon the needs of the particular hive, but in the present preferred embodiment is approximately 6.350 mm thick. The length of the flanges 13a, 13b may also vary as required, and according to a presently preferred embodiment are in the range of 4.568 mm to 8.056 mm.

As best shown in FIG. 3, each worker cell 20 consists of a shallow three-dimensional lattice of substantially equal length struts 22 defining a regular array of substantially equal closely packed rhombic lattice openings 24 such that each rhombic opening shares each of its four peripheral struts 22 with a respective adjacent rhombic opening 24. The cells 20 are dimensioned to accommodate worker bees, which are generally between 12 mm and 15 mm in length. The thickness “A” of struts 22 can be of any dimension that accommodates the worker bees, but is preferably approximately 0.533 mm thick. Similarly, the width “B” of a worker cell 20 can be any dimension that accommodates a typical worker be, with a preferred width being approximately 4.750 mm. Similarly, the distance from center to center “C” of adjacent worker cells 20 can be any dimension that accommodates a typical worker bee, with a preferred distance being approximately 5.283 mm. Standard worker cells are typically between 5.4 mm and 5.5 mm wide, although other widths are contemplated. Examples of further preferred dimensions for the widths “B” of worker cell 20 are as follows:

| Min | Avg | Max |
|---|---|---|
| 4.57 | 5.08 | 5.59 |
| 4.29 | 4.76 | 5.24 |
| 4.50 | 5.00 | 5.50 |

Similarly, and as best shown in FIG. 4, each drone cell 30 consists of a shallow three-dimensional lattice of substantially equal length struts 32 defining a regular array of substantially equal closely packed rhombic lattice openings 34 such that each rhombic opening shares each of its four peripheral struts 32 with a respective adjacent rhombic opening 34. The cells 30 are dimensioned to accommodate drone bees, which are generally larger than worker bees. The thickness “A” of struts 32 can be of any dimension that accommodates the drone bees, but is preferably approximately 0.533 mm thick. Similarly, the width “B” of a drone cell 30 is greater than the width of the worker cell 20, and can be any dimension that accommodates a typical drone bee, with a preferred width being approximately 5.867 mm. Similarly, the distance from center to center “C” of adjacent worker cells 30 can be any dimension that accommodates a typical drone bee, with a preferred distance being approximately 6.401 mm. Standard drone cells are typically between 6.4 mm and 6.6 mm wide, although other widths are contemplated. Examples of further preferred dimensions for the widths “B” of drone cell 30 are as follows:

| Min | Avg | Max |
|---|---|---|
| 5.72 | 6.35 | 6.99 |
| 5.36 | 5.95 | 6.55 |
| 5.63 | 6.25 | 6.88 |

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I claim:

1. An artificial honeycomb foundation for beehives comprising:
an array of hexagonally-shaped honeycomb cells, wherein a first group of said array of hexagonally-shaped honeycomb cells include cells of a first dimension sized to accommodate worker bees, and a second group of said array of hexagonally-shaped honeycomb cells include cells of a second, larger dimension sized to accommodate drone bees.

2. The artificial honeycomb foundation of claim 1, further comprising a dividing film wall which acts as a base for the artificial honeycomb foundation, said array of hexagonally-shaped honeycomb cells projecting from a front surface of said dividing film wall.

3. The artificial honeycomb foundation of claim 2 further comprising a second array of hexagonally-shaped honeycomb cells projecting from a rear surface of said dividing film wall, wherein a first group of said second array of hexagonally-shaped honeycomb cells include cells of a first dimension sized to accommodate worker bees, and a second group of said second array of hexagonally-shaped honeycomb cells include cells of a second, larger dimension sized to accommodate drone bees.

4. The artificial honeycomb foundation of claim 3, wherein the hexagonally-shaped honeycomb cells projecting from the front surface of the dividing film wall are offset from the hexagonally-shaped honeycomb cells projecting from the rear surface of the dividing film wall.

5. The artificial honeycomb foundation of claim 1 wherein the worker bee cells are between about 4.6 mm and 5.5 mm in width and the drone been cells are between about 6.4 mm and 6.6 mm in width.

6. The artificial honeycomb foundation of claim 1 wherein the worker bee cells are between about 4.57 mm and 5.59 mm in width, and the drone bee cells are between about 5.72 mm and 6.99 mm in width

7. The artificial honeycomb foundation of claim 5 wherein the worker bee cells are 5.08 mm in width and the drone bee cells are 6.35 mm in width.

8. The artificial honeycomb foundation of claim 1 wherein the worker bee cells are between about 4.29 mm and 5.24 mm in width, and the drone bee cells are between about 5.36 mm and 6.55 mm in width.

9. The artificial honeycomb foundation of claim 7 wherein the worker bee cells are 4.76 mm in width, and the drone bee cells are 5.95 mm in width.

10. The artificial honeycomb foundation of claim 1 wherein the worker bee cells are between about 4.50 mm and 5.50 mm in width, and the drone bee cells are between about 5.63 mm and 6.88 mm in width.

11. The artificial honeycomb foundation of claim 9 wherein the worker bee cells are 5.00 mm in width, and the drone bee cells are 6.25 mm in width.

12. The artificial honeycomb foundation of claim 1 wherein the drone bee cells account for less than fifteen percent of the array of hexagonally-shaped honeycomb cells.

13. The artificial honeycomb foundation of claim 12 wherein the drone bee cells account for approximately two percent of the array of hexagonally-shaped honeycomb cells.

14. The artificial honeycomb foundation of claim 1 wherein each cell in the array of hexagonally-shaped honeycomb cells consists of a shallow three-dimensional lattice of substantially equal length struts defining a regular array of substantially equal closely packed rhombic lattice openings such that each rhombic opening shares each of its four peripheral struts with a respective adjacent rhombic opening.

15. The artificial honeycomb foundation of claim 1 wherein the array of hexagonally-shaped honeycomb cell is formed from a plastic material.

16. The artificial honeycomb foundation of claim 15 wherein the plastic material is styrene.

17. The artificial honeycomb foundation of claim 1 wherein the array of hexagonally-shaped honeycomb cells is formed from wax.

18. The artificial honeycomb foundation of claim 1 wherein the array of hexagonally-shaped honeycomb cells is formed from metal.
